(19) United States
(12) Patent Application Publication
(10) Pub. No.: US 2004/0010781 A1
(43) Pub. Date: Jan. 15, 2004

(54) Parameter parsing system

(76) Inventors: John Warren Maly, LaPorte, CO (US); Ryan Clarence Thompson, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/194,474

(22) Filed: Jul. 12, 2002

(51) Int. Cl. G06F 9/45

(52) U.S. Cl. 717/143

(57) ABSTRACT

Techniques are disclosed for applying input parameters to a parameterized process, such as a computer software program. The input parameters may include both normal parameters and scope-specifying parameters. An input parameter parser initializes and maintains a current scope. The input parameter parser sequentially processes each of the input parameters. If the input parameter is a normal parameter, the parser applies the parameter to the parameterized process. If the input parameter is a scope-specifying parameter, the parser updates the current scope with the scope specified by the scope-specifying parameter. In this way, scope-specifying parameters specify the scope within which subsequent normal parameters are to be applied. The current scope remains in effect until and unless it is modified by one or more scope-specifying parameters. The input parameters may, for example, be implemented in a textual command line which may efficiently specify a variety of parameters having varying scopes.

### CROSS REFERENCE TO RELATED APPLICATIONS

This application is related to a co-pending and commonly owned patent application filed on Jun. 10, 2002, entitled “Accessing Resources in a Microprocessor Having Resources of Varying Scope”, Attorney Docket No. 100111376-1, which is hereby incorporated by reference.

### BACKGROUND

1. Field of the Invention

The present invention relates to parsing parameters of a process and, more particularly, to parsing parameters provided to a software program using a command line.

2. Related Art

Computer processors historically have been limited to executing a single instruction stream—referred to as a “thread”—at a time. Execution of multiple threads simultaneously in hardware has typically required the use of multiple processors configured in a multi-processing (MP) architecture. It typically has been necessary for operating systems and other software to be specially programmed to take advantage of the performance gains made possible by multi-processing.

Recently, processor architectures have been developed which enable a single processor to execute multiple threads concurrently (referred to herein as “hardware multithreading”). For example, Intel Corporation's Hyper-Threading technology allows a single processor to execute multiple threads concurrently, thereby acting as if it were two physical processors. Processors enabled with Hyper-Threading technology can manage incoming instructions from different software applications and continuously switch from one set of instructions to the other, every few nanoseconds, without losing track of the state of each set of instructions. Hyper-Threading Technology complements symmetric multi-processing (SMP) by allowing more threads to execute simultaneously per processor. Hyper-Threading technology is implemented, for example, in Intel's Xeon™ line of server processors.

More specifically, a processor based on Hyper-Threading technology implements two architectural states on a single processor core. Although each of the two logical processors has a distinct architectural state, they both share the processor core's single set of execution resources. The two logical processors may execute distinct threads concurrently. The architectural state that is duplicated for each logical processor includes data registers, segment registers, control registers, debug registers, Advanced Programmable Interrupt Controller (APIC) registers, and some machine-specific registers (MSRS). The execution resources shared by the logical processors include the execution engine, the caches, the system bus interface, and the firmware. After power-up and initialization, each logical processor may be individually halted, interrupted, or directed to execute a specific thread, independently of the other logical processor on the chip.

A single processor implementing Hyper-Threading technology will appear to operating systems and other software as if it were two distinct physical processors. Operating systems and other software may therefore interact with (e.g., schedule threads on) the two logical processors in the same way that they interact with physical processors in conventional multi-processing systems. Software that is already designed to run on a conventional multi-processing system may therefore run unmodified on a Hyper-Threading platform. In such a platform, the threads that would be dispatched to two or more physical processors in a conventional multi-processing system are dispatched to the two logical processors. Because two threads executing in two logical processors on a single physical processor share one set of execution resources, one thread may use execution resources that would otherwise be idle if only one thread were executing on the physical processor. The result is an increased utilization of the execution resources within each physical processor. Modern operating systems (such as Microsoft Windows® and Linux®) and other high-performance software which is already optimized for multi-threading and multi-processing environments may especially benefit from technologies such as Hyper-Threading.

Similarly, multi-core processors include multiple processor cores in a single chip package. A multi-core processor acts as if it were multiple processors. Each of the multiple processor cores may essentially operate independently, while sharing certain common resources, such as a cache. Multi-core processors therefore provide additional opportunities for increased processing efficiency. A single processor chip may include multiple cores, each of which may provide hardware multi-threading.

Various electronic design automation (EDA) software tools exist for designing microprocessors and other circuitry. Such tools allow circuit designers to create and modify virtual models of the circuit being designed. A circuit designer may, for example, specify a circuit design using a textual description written in a hardware description language (HDL), such as Verilog or VHDL, or by using a graphical user interface to manipulate a graphical representation of the circuit design.

Software tools are also used frequently for testing circuit designs. Circuit testing tools typically simulate the operation of the circuit design; the portion of the testing tool that performs this simulation is therefore called a “simulator.” To test a microprocessor design, for example, the circuit designer typically creates one or more “test cases.” A test case typically specifies a set of initial values for machine resources (such as registers, caches, and main memory) and a set of test microprocessor instructions for the simulator to execute. The test case may also include the outputs that are expected to result from performing the test instructions based on the initial values.

A software program called an “initializer” reads the test case and modifies the initial state of the simulated processor design to reflect the initial state values specified by the test case. Once the processor design is initialized, the simulator simulates the execution of the instructions specified by the test case and verifies that the expected output is produced as a result. A significant advantage of using such simulators for testing is that they may detect errors prior to the costly and time-consuming fabrication of the circuit itself.

In a multi-core and/or multi-thread architecture, certain resources—such as registers, caches, and main memory—may be shared by multiple cores and/or multiple threads. The “scope” of a resource refers to the extent to which the resource is shared among cores and/or threads. For example, a particular machine-specific register (MSR) may be shared (available for use) by all processor cores on a chip (and by all threads within all of the cores). Such a resource is therefore said to have a “chip-wide” or “chip-specific” scope. An MSR may also be specific to (i.e., only available for use by) a particular one of the processor cores (including all of the threads in that core). Such an MSR is said to have a “core-wide” or “core-specific” scope. Similarly, an MSR may be specific to (i.e., only available for use by) a particular thread in a particular one of the processor cores. Such an MSR is said to have a “thread-wide” or “thread-specific” scope. Different resources within the same processor may have different scopes. This is referred to herein as a “mixedscope machine resource” environment.

Computer resources are typically referred to by resource identifiers. A test case, for example, typically specifies initial values for machine resources by providing, for each resource, a resource identifier and an initial value for the resource. The identifier may, for example, be a label or other resource identifier, such as a register number in the case of a register or a memory address in the case of a memory location.

Similarly, the circuit designer may invoke the initializer using a textual command line in an operating system such as Unix or a variant thereof. Such a command line typically consists of the name of the initializer (such as “init”) followed by one or more parameters of the initializer. Each parameter typically includes a special leading character (such as a slash or a hyphen), followed by a character that identifies the parameter, optionally followed by one or more parameter values. For example, the command line “init -s128” might indicate that the initializer (identified by the name “init”) is to be invoked with a pseudo-random number generator seed (identified by the “-s”) having a value of 128. Conventional command lines may include multiple parameters. The initializer typically includes a command line parser which sequentially reads each of the command line parameters and applies them to the initialization process.

In a single-core, single-thread architecture, a single parameter, such as “-s128”, applies to the entire microprocessor design. In a multi-core and/or multi-thread architecture, however, it may be possible to seed each thread in each core separately. A parameter such as “-s128”, however, does not specify which thread in the microprocessor is to be seeded. Conventional command line syntaxes do not provide the ability to associate particular command line parameters with particular cores and/or particular threads in a mixed-scope resource environment. Conventional command line parameters, such as “-s128”, may therefore be of limited use for initializing multi-core and/or multi-thread microprocessor designs. Although this problem could be solved by appending a core and/or thread number to every parameter, the resulting command lines would potentially be very long and tedious to construct.

What is needed, therefore, are improved techniques for providing and parsing parameters provided to software programs.

### SUMMARY

Techniques are disclosed for applying input parameters to a parameterized process, such as a computer software program. The input parameters may include both normal parameters and scope-specifying parameters. An input parameter parser initializes and maintains a current scope. The input parameter parser sequentially processes each of the input parameters. If the input parameter is a normal parameter, the parser applies the parameter to the parameterized process. If the input parameter is a scope-specifying parameter, the parser updates the current scope with the scope specified by the scope-specifying parameter. In this way, scope-specifying parameters specify the scope within which subsequent normal parameters are to be applied. The current scope remains in effect until and unless it is modified by one or more scope-specifying parameters. The input parameters may, for example, be implemented in a textual command line which may efficiently specify a variety of parameters having varying scopes.

For example, in one aspect of the present invention, a computer-implemented method is provided which includes steps of: (A) receiving a first parameter of a process, the first parameter specifying a first scope; (B) receiving a second parameter of the process; and (C) applying the second parameter to the process within the first scope. Subsequent parameters may also be received and applied to the process within the first scope. The first and second parameters may be provided through and parsed from a textual command-line interface. The first scope may, for example, be a scope encompassing a particular thread and/or core in a multi-thread and/or multi-core microprocessor design.

The step (C) may include steps of: (C)(1) identifying a second scope of the second parameter; (C)(2) determining whether the second scope is equal to the first scope; and (C)(3) applying the second parameter to the process within the first scope if the second scope is determined to be equal to the first scope. The step (C) may further include steps of: (C)(4) determining whether the second scope is broader than the first scope; and (C)(5) applying the second parameter to the process within the second scope if the second scope is determined to be broader than the first scope. Alternatively or additionally, the step (C) may further include steps of: (C)(4) determining whether the second scope is narrower than the first scope; (C)(5) identifying a range of scopes; and (C)(6) applying the second parameter to all scopes in the range of scopes if the second scope is determined to be narrower than the first scope.

In another aspect of the present invention, a computer-implemented method is provided which includes steps of: (A) initializing a current scope of a process; (B) receiving a first parameter of the process; (C) determining whether the first parameter is a scope-specifying parameter which specifies a new scope of the process; (D) applying the first parameter to the process within the current scope if it is determined that the first parameter is not a scope-specifying parameter; and (E) if it is determined that the first parameter is a scope-specifying parameter, performing steps of: (1) updating the current scope with the new scope; (2) receiving a second parameter of the process; and (3) applying the second parameter to the process within the updated current scope. The first and second parameters may be provided through and parsed from a textual command-line interface. The first scope may, for example, be a scope encompassing a particular thread and/or core in a multi-thread and/or multicore microprocessor design.

Other features and advantages of various aspects and embodiments of the present invention will become apparent from the following description and from the claims.

### BRIEF DESCRIPTION OF THE DRAWINGS

FIG. 1 is a data flow diagram of a system for parsing a plurality of input parameters to a circuit design-and-test system according to one embodiment of the present invention;

FIG. 2 is a diagram of a plurality of input parameter definitions provided as input to an input parameter parser according to one embodiment of the present invention;

FIG. 3 is a block diagram of a stream of input parameters provided to an input parameter parser according to one embodiment of the present invention;

FIG. 4A is a flow chart of a method performed by an input parameter parser to apply a plurality of input parameters to a parameterized process according to one embodiment of the present invention;

FIG. 4B is a flow chart of the method of FIG. 4A in an embodiment in which the parameterized process is an initialization process which initializes a multi-core, multithread microprocessor design;

FIG. 4C is a flow chart of a method for applying a parameter to a parameterized process within a particular scope according to one embodiment of the present invention;

FIG. 4D is a flow chart of the method of FIG. 4C in an embodiment in which the parameterized process is an initialization process which initializes a multi-core, multithread microprocessor design; and

FIG. 4E is a flow chart of a method for identifying the resource scope specified by a combination of a core identifier and a thread identifier according to one embodiment of the present invention.

### DETAILED DESCRIPTION

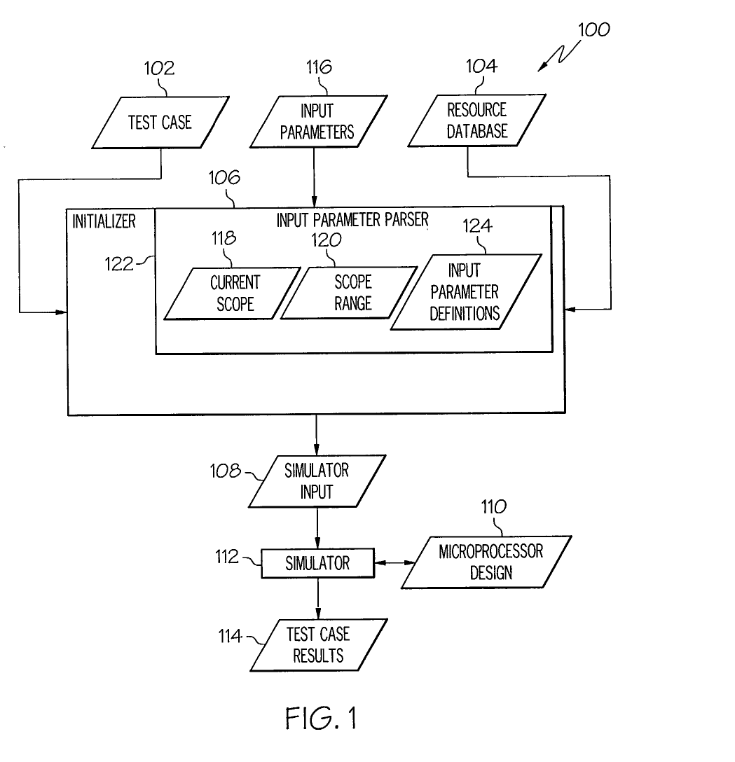

Referring to FIG. 1, a system 100 is illustrated for parsing a plurality of input parameters 116 to a circuit design-and-test system according to one embodiment of the present invention. The microprocessor design 110, also referred to as a hardware model under test or design under test (DUT), is a software (simulated) model of a microprocessor. The microprocessor design 110 models both the operation of the microprocessor (e.g., the functional relationship between inputs and outputs of the microprocessor) and the state of the microprocessor's machine resources, such as its registers, cache(s), and main memory, at a particular point in time.

The microprocessor design 110 may have a multi-core and/or multi-thread microprocessor architecture, in which case the microprocessor design 110 models the state of each core and/or thread in the architecture. The microprocessor design 110 may be implemented, for example, in a data structure in the memory of a computer or in a file stored on a hard disk or other computer-readable medium.

The system 100 also includes a resource database 104, which both defines the scope of each of the microprocessor design's machine resources and provides default values for each such resource. The resource database 104 is described in more detail in the above-referenced patent application entitled “Accessing Resources in a Microprocessor Having Resources of Varying Scope.”

The system 100 includes a test case 102, which includes test vectors that specify both initial values for the (simulated) machine resources of the microprocessor design 110 and test instructions to be executed (in simulation) by the microprocessor design 110. The test case 102 may, for example, be implemented in a file stored on a computer-readable medium or as a data structure in the memory of a computer. The test case 102 is described in more detail in the above-referenced patent application entitled “Accessing Resources in a Microprocessor Having Resources of Varying Scope.”

The system 100 also includes an initializer 106 and a simulator 112, both of which may be implemented as software programs written in any appropriate programming language, such as the C programming language. The initializer 106 initializes the state of the microprocessor design 110 based on the initial machine resource values provided in the test case 102 and the machine resource definitions provided in the resource database 104. In one embodiment, for example, the initializer 106 receives the test case 102 and the resource database 104 as inputs and produces simulator input 108 as an output. The simulator input 108 specifies the initial values of the microprocessor's machine resources, the test instructions to be executed, and the expected output produced by executing such instructions, in a format suitable for input to the simulator 112.

The simulator 112, in conjunction with the microprocessor design 110, provides an independent architectural reference model of the microprocessor. The simulator 112 receives the simulator input 108 and initializes the (simulated) machine resources of the microprocessor design 110 with the initial values specified in the simulator input 108.

Once the microprocessor design 110 has been initialized, the simulator 112 simulates execution of the instructions specified in the simulator input 108 on the microprocessor design 110. The simulator 112 modifies the state of the microprocessor design 110 accordingly as the simulation progresses. The simulator 112 produces test case results 114 which indicate, for example, whether the output produced by executing the test instructions matches the expected output specified by the simulator input 108.

The initialization process performed by the initializer 106 may be parameterized. In other words, the initializer 106 may accept a number of input parameters 116 which control various aspects of the initialization process. A user of the system 100, such as a circuit designer, may provide the input parameters 116 to the initializer 106 in any of a variety of ways. The user may, for example, provide the input parameters 116 to the initializer 106 in the form of a textual command line in an operating system such as Unix. A particular example of the input parameters 116 is described below with respect to FIG. 3. The initializer 106 may include an input parameter parser 122 which parses the input parameters 116 and applies them to the initialization process performed by the initializer 106. The input parameter parser 122 may, for example, be part of the same software program as the initializer 106.

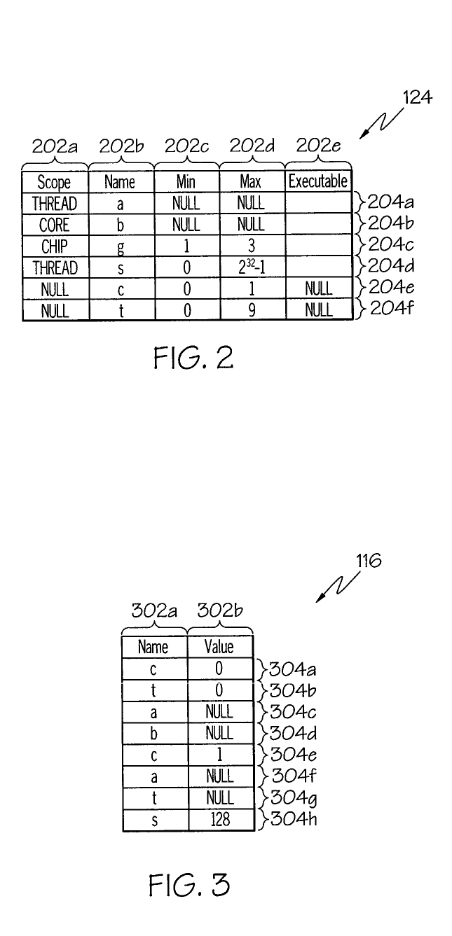

The input parameters 116 are defined in accordance with input parameter definitions 124. Referring to FIG. 2, an example of the parameter definitions 124 is shown. The 12 parameter definitions 124 are illustrated in the form of a table having columns 202a-e and rows 204a-d. In practice, the parameter definitions 124 may be implemented in any of a variety of forms, such as a table generated by word processing or spreadsheet software, a header file or other source code file written in a programming language such as C, or a database file. The parameter definitions 124 may, for example, be integrated into the source code of the initializer 106.

The parameter definitions 124 include six definitions 204a-f, each of which defines a particular parameter of the initialization process. Although six definitions 204a-f are shown, there may be any number of input parameter definitions. Parameter definitions 124 include five fields 202a-e. Scope field 202a indicates the scope of the corresponding parameter. In the embodiment illustrated in FIG. 2, the scope field 202a may have any one of three values—THREAD, CORE, and CHIP, indicating that the defined parameter has thread-specific scope, core-specific scope, or chip-specific scope, respectively. A parameter that has thread-specific scope applies to a particular thread in the microprocessor design 110. Similarly, a parameter that has core-specific scope applies to a particular core (and therefore to all threads within that core) of the microprocessor design 110. A parameter that has chip-specific scope applies to the entire microprocessor design 110 (i.e., to all cores and threads in the microprocessor design 110). The scope defined by the scope field 202a of a parameter's definition is referred to herein as the parameter's “defined scope.” Particular examples of parameters of varying scopes will be described below with respect to FIG. 3.

Name field 202b indicates the name of the corresponding parameter. This may be any label, text string, or other identifier. If the input parameters 116 are implemented in a textual command line, the name field 202b may, for example, specify a unique single-character name.

A parameter may or may not have an associated value. If the parameter has an associated value, minimum field 202c specifies the parameter's minimum value, and maximum field 202d specifies the parameter's maximum value. The input parameter definitions 124 may specify acceptable values for a particular parameter in any way, such as by specifying a list of acceptable values or by specifying a formula or other function which a parameter value must satisfy. If a parameter has no associated value, the minimum 202c and maximum 202d fields may, for example, be empty or contain a NULL value.

Executable code field 202e specifies executable software code to be executed by the input parameter parser 122 when applying the corresponding parameter to the initialization process. As described in more detail below, the input parameter parser 122 may read each of the input parameters 116 and apply them to the initialization process. In one embodiment, the input parameter parser 122 applies a parameter to the initialization process by executing the executable code 202e associated with the parameter. More generally, however, the input parameter parser 122 may “apply” the input parameters 116 to the initialization process in any manner. Although the contents of the executable code fields 202e of definitions 204a-d are illustrated as empty in FIG. 2, in practice the executable code fields 202e may contain any kind of program code, such as object code, source code, or parameters to be provided to another software routine for applying parameters to the initialization process.

The individual input parameter definitions 204a-f will now be described in more detail. Input parameter definition 204a defines an input parameter named “a” (field 202b) having a scope of THREAD (column 202a). The “a” parameter may have a Boolean value of either TRUE or FALSE. If, for example, the “a” parameter is included in the input parameters 116, the “a” parameter may be assumed to have a value of TRUE, and if the “a” parameter is omitted from the input parameters 116, the “a” parameter may be assumed to have a value of FALSE. In other words, the value of the “a” parameter may be inferred from its inclusion or omission in the input parameters 116, and the user therefore need not explicitly provide a value for the “a” parameter. As a result, in the embodiment illustrated in FIG. 2, the minimum 202c and maximum 202d values of the “a” parameter are null values.

A value of TRUE for the “a” parameter instructs the initializer 106 to automatically load all memory specified in the test case 102 to all levels of cache. When the value of the “a” parameter is TRUE, the initializer 106 ignores any labels in the test case 102 which instruct the initializer 106 not to load data to a level of cache. When the “a” parameter has a value of FALSE (e.g., when the input parameters 116 do not include the “a” parameter), the initializer 106 initializes memory into caches as specified by the test case 102. The fact that the “a” parameter has thread-wide scope means that the “a” parameter is applied to a particular thread in a particular core. The “a” parameter may, for example, have a value of TRUE for one thread and a value of FALSE for another thread.

Input parameter definition 204b defines an input parameter named “b” (field 202b) having a scope of CORE (column 202a). The fact that the “b” parameter has core-wide scope means that the “b” parameter is applied to a particular core and therefore to all threads in the core. The “b” parameter may have a Boolean value of either TRUE or FALSE. When the value of the “b” parameter is TRUE, the initializer 106 automatically computes branch predictions for the corresponding core. When the value of the “b” parameter is FALSE, the initializer 106 does not automatically compute branch predictions for the corresponding core.

Input parameter definition 204c defines an input parameter named “g” (field 202b) having a scope of CHIP (column 202a). The fact that the “g” parameter has chip-wide scope means that the “g” parameter is applied to the entire chip, and therefore to all cores and threads in the microprocessor design 110. In one embodiment, the “g” parameter may be passed to the initializer 106 between zero and three times with values of 1, 2, or 3 (as indicated by minimum 202c and maximum 202d fields). In this way, the “g” parameter tells the initializer 106 to generate zero or more symmetric agents. The initializer 106 will generate initialization information for each of the specified agents, if any.

A symmetric agent is a virtual processor that appears to exist in the same system of the microprocessor design 110. Data initialized into the microprocessor design's caches may be initialized into the symmetric agents' caches as well. This allows the simulator 112 to test processor-to-processor communication behavior.

Input parameter definition 204d defines an input parameter named “s” (field 202b) having a scope of THREAD (column 202a). The “s” parameter provides a pseudo-random number generator (PRNG) seed to be used in conjunction with the corresponding thread. The initializer 106 may, for example, use pseudo-random numbers to initialize some resources for which initial values are not explicitly assigned in the test case 102. The value of the “s” parameter specifies the value of the seed to be used. In the embodiment illustrated in FIG. 2, the value of the “s” parameter is a single 32-bit word having a value in the range zero (column 202c) to 2³²-1 (column 202d).

The parameters defined by input parameter definitions 204a-d are referred to herein as “normal” input parameters. The input parameter definitions 124 also include two special parameter definitions 204e-f. Parameter definition 204e, for example, defines a parameter named “c” (column 202b) which is used to specify a core scope to be applied to other parameters in the input parameters 116. Similarly, parameter definition 204f defines a parameter named “t” (column 202b) which is used to specify a thread scope to be applied to other parameters in the input parameters 116. The “c” (core) and “t” (thread) parameters are referred to herein as “scope-specifying parameters” because they specify the scope of other parameters. The parameter definitions 204e-f are designated as defining scope-specifying parameters by the inclusion of NULL values in their scope field 202a. Parameters may be designated as scope-specifying parameters, however, in any of a variety of ways.

The “c” parameter has a range of zero to one (columns 202c and 202d), indicating that in the present example the microprocessor design 110 has two cores. The “t” parameter has a range of zero to nine (columns 202c and 202d), indicating that in the present example each core in the microprocessor design 110 has ten threads. The executable code field 202e of definitions 204e and 204f are illustrated as having NULL values because the executable code field 202e is not applicable to scope-specifying parameters in the present embodiment. The use of the “c” and “t” parameters will be described in more detail below.

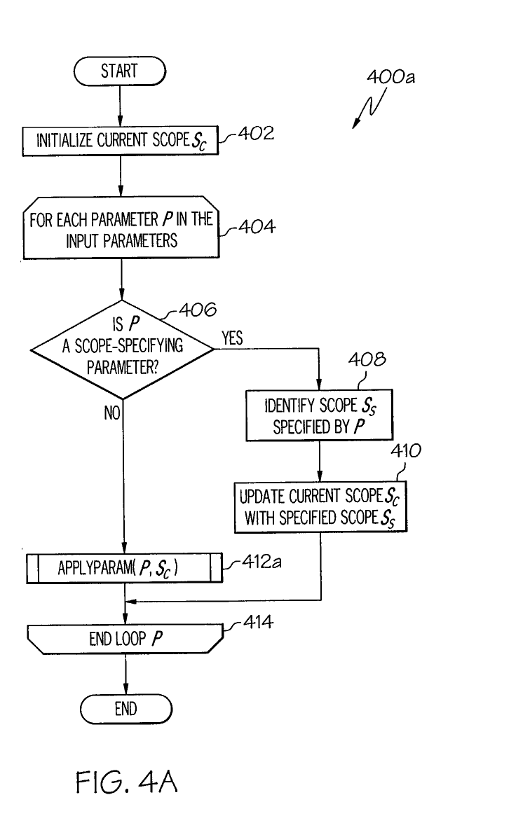

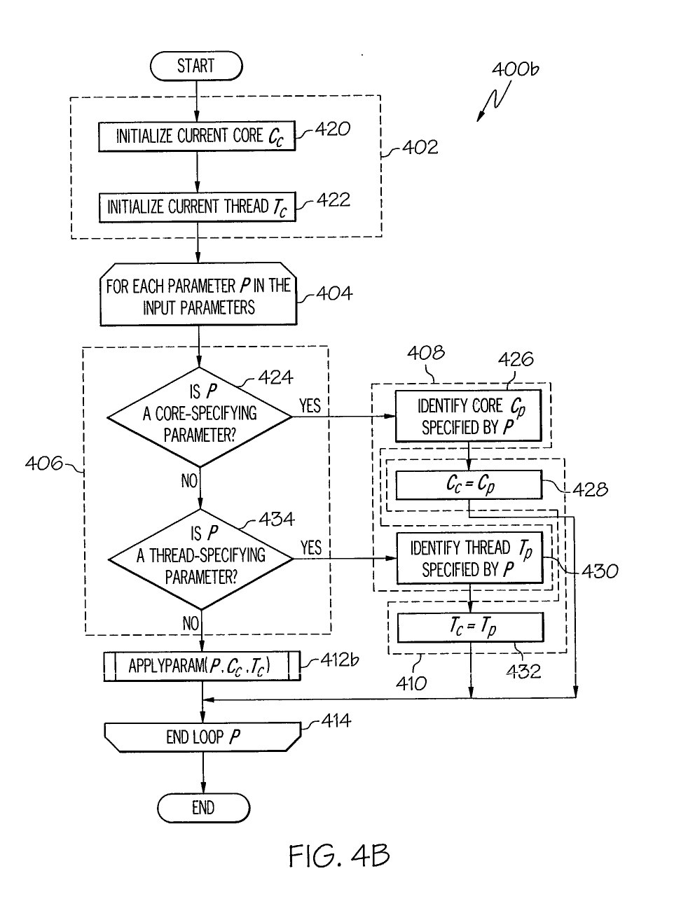

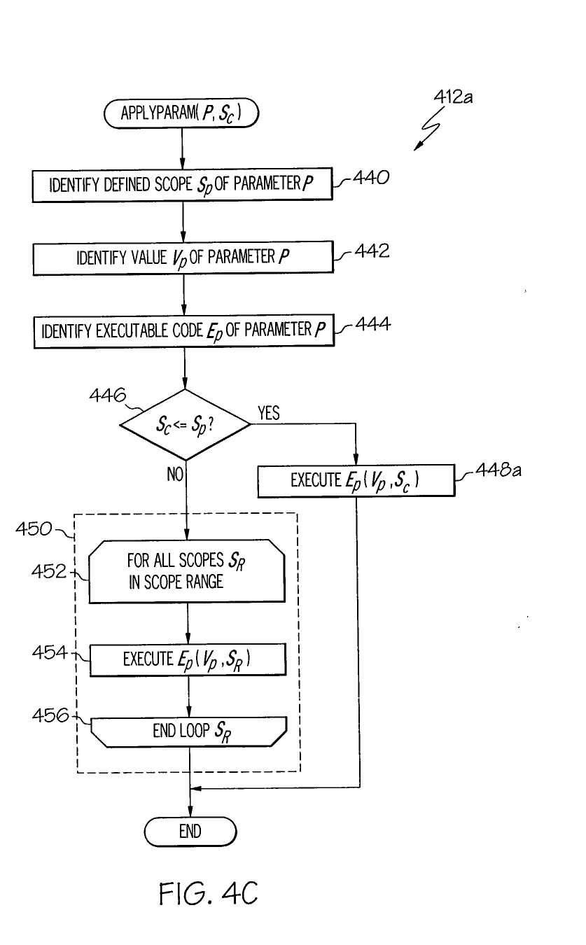

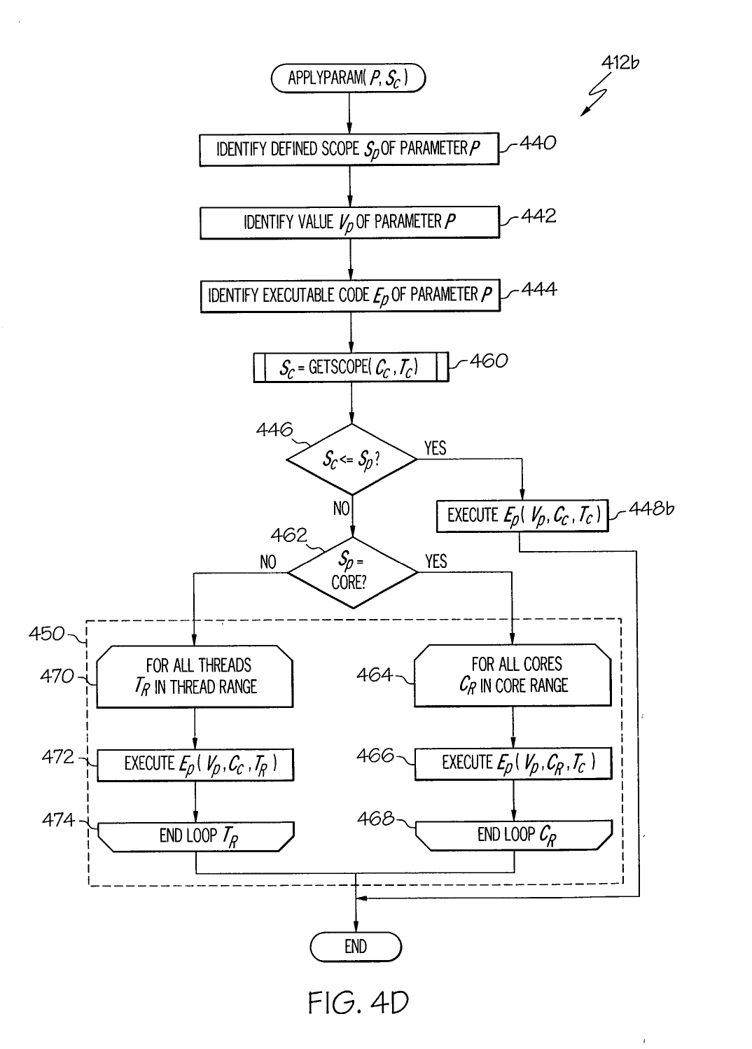

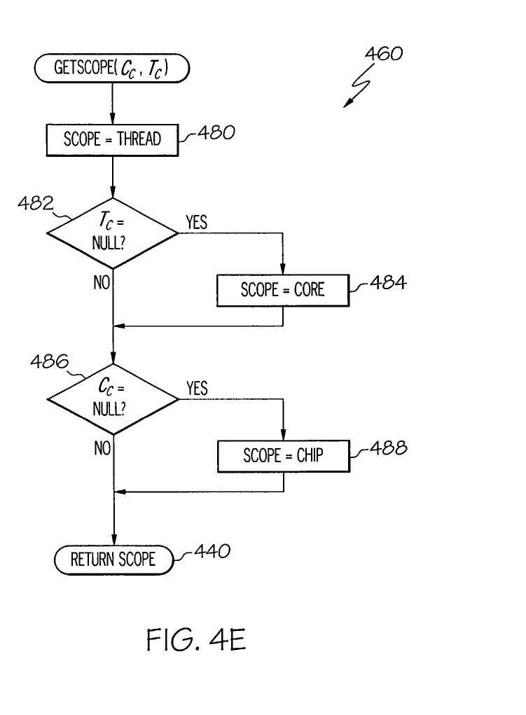

Operation of the input parameter parser 122 will now be described in more detail. Referring to FIG. 4A, a flow chart is shown of a method 400a performed by the input parameter parser 122 to apply the input parameters 116 to the initialization process performed by the initializer 106 according to one embodiment of the present invention. The method 400a shown in FIG. 4A may, however, be applied more generally to any kind of process having parameters, referred to herein as a “parameterized process.” In general, the method 400a initializes and maintains a current scope S_{C} (illustrated as current scope 118 in FIG. 1) The current scope S_{C} has a range 120 of permissible values. The method 400a reads the input parameters 116 and sequentially applies them to the parameterized process. The method 400a applies normal parameters to the parameterized process by applying them within the current scope S_{C}. The method 400a applies scope-specifying parameters (such as “c” and “t”) by updating the current scope S_{C} with the scope specified by the scope-specifying parameters. The current scope S_{C} therefore remains in effect unless and until it is updated by a scope-specifying parameter. Each normal parameter is therefore applied within the scope specified by the most-recently encountered scope-specifying parameter(s). In other words, the current scope S_{C} is specified by the most-recently applied scope-specifying parameter(s). In this way, the user of the system 100 may use scope-specifying parameters to specify the scope of subsequent parameters in the input parameters 116, thereby obviating the need to explicitly specify a scope for each of the input parameters 116.

More specifically, the method 400a initializes a variable S_{C} representing the current scope (step 402). If, for example, the microprocessor design 110 has a single-core, multi-thread architecture, the current scope S_{C} may specify a particular thread, and may be initialized in step 402 to a value of NULL or to a default thread number, such as zero. A scope having a NULL value or other undefined or out-of-range value may be employed to refer to the broadest allowable scope. For example, in the context of a single-core, multi-thread microprocessor design, a NULL scope may refer to a scope encompassing all threads in the microprocessor design.

The method 400a enters a loop over each parameter P in the input parameters 116 (step 404). The method 400a determines whether parameter P is a scope-specifying parameter (step 406). For example, as described above with respect to FIG. 2, the core (“c”) and thread (“t”) parameters are scope-specifying parameters, while the remaining parameters (“a”, “b”, “g”, and “s”) are not scope-specifying parameters. The method 400a may determine whether parameter P is a scope-specifying parameter by: (1) identifying the parameter definition of P using the name 302a of P as an index into the parameter definitions 124; and (2) examining the scope field 202a of the identified parameter definition to determine whether the scope is NULL (which indicates that the corresponding parameter is a scope-specifying parameter).

If parameter P is a scope-specifying parameter, the method 400a identifies the scope S_{S} specified by parameter P (step 408). For example, parameter 304b (FIG. 3) specifies a thread-specific scope of thread zero (column 302b). The method 400a updates the current scope S_{C} with the specified scope S_{S} (step 410). This update may be performed in any of a variety of ways. If, for example, the microprocessor design 110 has a single-core, multi-thread architecture, the current scope S_{C} may be represented by a single variable representing the current thread scope. In such a case, the method 400a may update the current scope S_{C} with the scope Ss specified by P by replacing the current value of S_{C} with the value of S_{S}.

If parameter P is not a scope-specifying parameter (step 406), the method 400a applies the parameter P to the initialization process (or other parameterized process to which the method 400a is being applied) within the current scope S_{C} (step 412a). The method 400a performs step 412a by calling a subroutine named ApplyParam with two parameters: (1) the parameter P, and (2) the current scope S_{C}. The method 400a repeats steps 406-412a for the remaining parameters (step 414) and then terminates.

Although the term “scope” may refer to the scope of a machine resource in the microprocessor design 110, this is not a limitation of the present invention. Rather, applying a parameter P within the current scope S_{C} has a broader meaning. As described above, a parameter P may have one or more associated values. The “s” parameter, for example, has a single associated value V which specifies a seed. This value will be referred to herein as an “explicit” value because the user of the system 100 must explicitly specify the value in the input parameters. Such a parameter, however, may be considered to have two additional, implicit, values which specify a core and thread, respectively. The current scope S_{C} may be viewed as a mechanism for providing these implicit values to a parameter without requiring the user of the system 100 to explicitly provide them for each of the input parameters 116. The user need only provide the “s” parameter's explicit (seed) value, while the input parameter parser 122 provides the “s” parameter's implicit core and thread values using the techniques described herein.

Referring again to FIG. 4A, in step 412a the method 400a applies the parameter P to the parameterized process within the current scope S_{C} by calling the ApplyParam subroutine (step 412a). Referring to FIG. 4C, a flowchart of one embodiment of the ApplyParam subroutine executed in step 412a is shown.

The subroutine 412a identifies the defined scope S_{P} of parameter P (step 440). The subroutine 412a may, for example, perform step 440 by (1) identifying the definition of parameter P using the name of P as an index into the parameter definitions 124; and (2) examining the scope field 202a of the identified parameter definition. The subroutine 412a identifies the value V_{P} of parameter P (step 442). The subroutine 412a may, for example, identify value V_{P} with reference to value field 302b (FIG. 3).

The subroutine 412a identifies the executable code E_{P} associated with parameter P (step 444). For example, the subroutine 412a may identify the executable code E_{P} associated with parameter P (step 444) with reference to the executable code field 202e of the corresponding parameter definition (FIG. 2).

The subroutine 412a determines whether the current scope S_{C} is narrower than or equal to the defined scope S_{P} (step 446). Step 446 may be performed in any of a variety of ways. For example, in a single-core, multi-thread architecture, there may be two scopes: thread-wide scope (THREAD) and core-wide scope (CORE). In such an architecture, CORE scope is broader than THREAD scope. Similarly, in a multi-core, multithread architecture, there may be three scopes: thread-wide scope (THREAD), core-wide scope (CORE), and chip-wide scope (CHIP). In such an architecture, CHIP scope is broader than CORE scope, which is in turn broader than THREAD scope. The subroutine 412a may, for example, use these definitions of relative scope breadth to determine whether the current scope S_{C} is narrower than or equal to the defined scope S_{P} in step 446.

If the current scope S_{C} is narrower than or equal to the defined scope S_{P} (step 446), the subroutine 412a applies the parameter P to the parameterized process within the scope S_{C}. If the current scope S_{C} is narrower than the defined scope S_{P}, the current scope S_{C} is more specific than the defined scope S_{P}. In this case, the current scope S_{C} is said to “overspecify” the parameter P. For example, at the time that parameter 304d is applied, the current scope S_{C} is THREAD (defined as core zero, thread zero by parameters 304a and 340b). This is more specific than the CORE scope of parameter 304d.

The executable code E_{P} takes as input two parameters: (1) the parameter value V_{P}, and (2) the current scope S_{C}. For example, a parameter having thread-wide scope, such as the “s” parameter 204a, takes as input both a seed value and a scope identifier in the form of a thread number. The executable code E_{P} may therefore be viewed as a function with two parameters, which may be expressed as E_{P}(V_{P}, S_{C}). In conventional systems, the executable code for a parameter does not take the scope S_{C} as a parameter. Using the techniques disclosed herein, the user need not provide an explicit scope for each input parameter because the input parameter parser 122 maintains the current scope S_{C} and applies it to the input parameters 116 automatically.

Some parameters may not require the parameter value V_{P}, in which case the parameter value V_{P} may be omitted or provided as a NULL value. The subroutine 412a may apply the parameter P to the parameterized process within the current scope S_{C} by calling the executable code E_{P} with the value V_{P} and the scope S_{C} (step 448a). If the current scope S_{C} is narrower (more specific) than the defined scope S_{P}, the executable code E_{P} may ignore some or all of the current scope S_{C}. Alternatively, the current scope S_{C} may be omitted as a parameter to the executable code E_{P} if the current scope S_{C} is narrower than the defined scope S_{P}. Particular examples of this case will be described below with respect to FIG. 4D.

If the current scope S_{C} is broader than the defined scope S_{P} (step 446), the subroutine 412a applies the parameter P to the parameterized process within all scopes in the scope range 120 (step 450). More specifically, the subroutine 412a enters a loop over all scopes S_{R} in the scope range 120 (step 452). The scope range S_{R} may, for example, be a numerical range of scope values (such as zero through nine in a microprocessor architecture having ten threads) or a list of permissible scopes. The subroutine 412a calls the executable code E_{P} with the value V_{P} and the scope S_{R} (step 454). The subroutine 412a repeats step 454 for all scopes S_{R} in the scope range 120 (step 456). In this way, the subroutine 412a applies the parameter P to all scopes within the scope range 120.

Referring to FIG. 4B, a flow chart of a method 400b is shown in which the method 400a has been customized to apply to a multi-core, multi-thread microprocessor design, such as microprocessor design 110. In this embodiment, the current scope S_{C} includes two sub-scopes: a current core scope C_{C} and a current thread scope T_{C}. The method 400b implements step 402 (initializing the current scope S_{C}) by initializing both the current core scope C_{C} (step 420) and the current thread scope T_{C} (step 422). The scopes C_{C} and T_{C} may, for example, be initialized to default core and thread numbers (such as zero and zero, respectively), or to NULL values. The meaning of NULL core and/or thread values will be described in more detail below with respect to FIG. 4E.

Operation of the method 400b illustrated in FIG. 4B will be described with respect to the example input parameters 304a-h illustrated in FIG. 3 for purposes of example. The input parameters 116 are illustrated in FIG. 3 in the form of a table having columns 302a-b (alternatively referred to as fields) and rows 304a-h. In practice, the input parameters 116 may be implemented in any of a variety of forms, such as a textual command line, a table generated by word processing or spreadsheet software, a header file or other source code file written in a programming language such as C, or a data structure tangibly stored in the memory of a computer, such as a database file.

For purposes of example, the table illustrated in FIG. 3 provides input parameters to be applied by the initializer 106 to the initialization process (i.e., the process which produces the simulator input 108). Although only a small number of input parameters 116 are illustrated in FIG. 3 for ease of illustration and explanation, there may be any number and combination of input parameters 116.

The input parameters 116 includes parameters 304a-h, each of which includes both a name 302a and a value 302b. Some parameters may not require or allow associated values, in which case the value field 302b may contain a NULL value (such as −1 or some other undefined or out-of-range value) or be omitted.

For example, input parameter 304a has a name 302a of “c” and a value 304a of zero. The “c” parameter, as described above, is a scope-specifying parameter which specifies the scope of subsequent ones of the input parameters 116. The “c” parameter specifies a core-wide scope; in particular, the zero value 302b of parameter 304a indicates that the parameter 304a specifies a scope of core zero.

Similarly, input parameter 304b has a name 302a of “t” and a value 304a of zero. The “t” parameter, as described above, is a special parameter which specifies the scope of subsequent ones of the input parameters 116. The “t” parameter is therefore another example of a “scope-specifying” parameter. The “t” parameter specifies a thread-wide scope; in particular, the zero value 302b of parameter 304b indicates that the parameter 304b specifies a scope of thread zero. Therefore, in combination, the parameter specifiers 304a and 304b specify a thread-specific scope of core zero, thread zero. This is referred to herein as the “current scope.” Although the description herein may refer to “core numbers” and “thread numbers,” these and other numbers that may be used to identify machine resources may more generally be considered to be resource identifiers, which may be numeric or non-numeric. Machine resources may, for example, be referred to by textual labels in any combination of the input parameters 116, test case 102, the resource database 104, and the simulator input 108.

As described in more detail below, the input parameter parser 122 reads the input parameters 116 sequentially and applies them to the initialization process in sequence. The remaining parameters 304c-h will be described below with respect to FIG. 4A.

Returning to FIG. 4A, the method 400a enters a loop over each parameter P in the input parameters 116 (step 404). In the present example, the first parameter encountered by the method 400a is the parameter 304a (FIG. 3), which has a name of “c” and a value of zero.

The method 400b determines whether parameter P is a scope-specifying parameter (step 406). The method 400b performs step 406 by determining whether parameter P is either a core-specifying parameter (step 424) (i.e., the “c” parameter) or a thread-specifying parameter (step 434) (i.e., the “t” parameter).

If parameter P is a “c” (core) parameter, the method 400b identifies the core C_{P} specified by parameter P (step 426) and assigns the value C_{P} to the current core C_{C} (step 428). In the present example, the parameter 304a is a core-specifying parameter. The method 400b may, for example, identify the core C_{P} (zero in this example) from the value field 302b of parameter P. The value of the current core C_{C} has now been updated with the core C_{P} specified by parameter P and is therefore equal to zero.

The method 400b continues to the next parameter 304b, which is a thread-specifying parameter having the name “t” and value zero. If parameter P is a “t” (thread) parameter, the method 400b identifies the thread T_{P} specified by parameter P (step 430) and assigns the value T_{P} to the current thread T_{C} (step 432). In the present example, the parameter 304b is a thread-specifying parameter. The method 400b may, for example, identify the thread T_{P} from the value field 302b of parameter P. The value of the current thread T_{C} has now been updated with the thread T_{P} specified by specifier P, and is therefore equal to zero. At this point, therefore, the value of the current core C_{C} is equal to zero and the value of the current thread T_{C} is equal to zero.

The method 400b continues to the next parameter 304c, which is a normal parameter having the name “a” and value NULL (i.e., no value). If parameter P is neither a core-specifying parameter nor a thread-specifying parameter (i.e., if parameter P is a normal parameter), the method 400b applies the parameter P to the initialization process within the current scope S_{C} by calling a subroutine named ApplyParam with the parameters P, C_{C}, and T_{C} (step 412b). Because the parameter 304c in this example is a normal parameter, the method 400b applies parameter 304c to the initialization process within the current scope of core zero, thread zero. The method 400b performs step 412b by calling a subroutine named ApplyParam with three parameters: (1) the parameter P, (2) the current core scope C_{C} (zero in this example) and (3) the current thread scope T_{C} (zero in this example).

The method 400b applies the next parameter 304d, which is a normal parameter having the name “b” and value NULL, in a similar manner. Note, however, that because the “b” parameter has a core-specific scope (FIG. 2, column 202a), the ApplyParam subroutine 412b may ignore the current thread TC when applying parameter 304d to the initialization process.

The method 400b continues to the next parameter 304e, which is a core-specifying parameter specifying core one. The method 400b therefore updates the value of the current core C_{C} to have a value of one (step 428). The current scope S_{C} at this point is therefore core one, thread zero. The method 400b then applies the next parameter 304f, which is a normal parameter having the name “a” and a NULL value, within the new current scope S_{C}.

The method 400b continues to the next parameter 304g, which is a thread-specifying parameter having a NULL value. A NULL value may be used to “reset” some or all of the current scope S_{C} (such as the current core C_{C} or the current thread T_{C}). Any of a variety of other techniques may alternatively be used to reset the current scope S_{C}. In this example, the parameter 304g resets the current thread T_{C} so that the current scope S_{C} is no longer thread-specific. Therefore, upon applying the parameter 304g (step 432), the current scope S_{C} is a core-specific scope of core one.

The method 400b continues to the next parameter 304h, which has the name “s” and the value 128. The method 400b applies the parameter 304h within the current scope (step 412b). Application of the parameters 304a-h is now complete.

It should be appreciated that during execution of the method 400b the current scope S_{C} is defined by a combination of the core specified by the most recently-applied core-specifying parameter and the thread specified by the most-recently applied thread-specifying parameter in the input parameters 116.

Referring to FIG. 4D, a flowchart of one embodiment of the ApplyParam subroutine executed in step 412b of method 400b (FIG. 4B) is shown. As described above with respect to FIG. 4B, the ApplyParam subroutine 412b is applied within the context of a multi-core, multi-thread microprocessor design.

The subroutine 412b identifies the defined scope S_{P} of parameter P (step 440), the value V_{P} of parameter P (step 442), and the executable code E_{P} associated with parameter P (step 444), as described above with respect to FIG. 4C. The subroutine 412b identifies the current scope S_{C} specified by the combination of current core C_{C} and current thread TC (step 460). The subroutine 412b may, for example, identify the current scope S_{C} by calling a subroutine named GetScope with the parameters C_{C} and T_{C}.

For example, referring to FIG. 4E, a flow chart of the method performed by the GetScope subroutine 460 in one embodiment of the present invention is shown. The GetScope subroutine 460 takes as inputs two parameters: C_{C}, a specified core number, and T_{C}, a specified thread number. The GetScope subroutine 460 determines the scope that is specified by the core number C_{C} and the thread number T_{C}. The subroutine 460 stores the specified scope in a variable named Scope, which is initialized to a value of THREAD (step 480). If the value of T_{C} is NULL (step 482), the subroutine 460 assigns a value of CORE to the variable Scope (step 484). If the value of C_{C} is NULL (step 486), the subroutine 460 assigns a value of CHIP to the variable Scope (488). The subroutine 460 returns the value of Scope to the calling routine, i.e., to the ApplyParam subroutine 412b (step 490).

The effect of the GetScope subroutine 460 is the following: (1) a non-NULL value for both the thread and core numbers T_{C} and C_{C} is interpreted as specifying a thread-specific scope (THREAD); (2) a non-NULL value for the core number C_{C} and a NULL value for the thread number T_{C} is interpreted as specifying a core-specific scope (CORE); and (3) a NULL value for both the thread and core numbers T_{C} and C_{C} is interpreted as specifying a chip-specific scope (CHIP).

Returning to FIG. 4D, the subroutine 412b determines whether the current scope S_{C} is narrower than or equal to the defined scope S_{P} (step 446), as described above with respect to FIG. 4C. If the current scope S_{C} is narrower than or equal to the defined scope S_{P} (step 446), the subroutine 412b applies the parameter P to the parameterized process within the scope S_{C} by, for example, calling the executable code E_{P} with the parameters V_{P}, C_{C}, and T_{C} (step 448b).

If the current scope S_{C} is broader than the defined scope S_{P} (step 446), the subroutine 412b determines whether the defined scope S_{P} is equal to CORE (step 462). If it is, the subroutine 412b applies the parameter P within thread T_{C} of all cores of the microprocessor design 110. In particular, in this embodiment, the scope range 120 includes two ranges: a core range R_{C} and a thread range R_{T}. For example, referring again the FIG. 2, the core range R_{C} may have a minimum of zero (column 202c) and a maximum of one (column 202d), while the thread range R_{T} may have a minimum of zero (column 202c) and a maximum of nine (column 202d). The subroutine 412b enters a loop over all cores C_{R} in the core range (step 464). The subroutine 412b calls executable code E_{P} with the parameters V_{P}, C_{R}, and T_{C} (step 466). The subroutine 412b repeats step 466 for all cores C_{R} in the core range (step 468).

If the current scope S_{C} is broader than the defined scope S_{P} (step 446) and the defined scope S_{P} is not equal to CORE (step 462), then the defined scope S_{P} is equal to THREAD. In this case, the subroutine 412b applies the parameter P within all threads of core C_{C}. The subroutine 412b enters a loop over all threads T_{R} in the thread range (step 470). The subroutine 412b calls executable code E_{P} with the parameters V_{P}, C_{C}, and T_{R} (step 472). The subroutine 412b repeats step 472 for all threads T_{R} in the thread range (step 474).

The input parameters 116 may, for example, be implemented as a textual command line provided to the input parameter parser 122 through a textual command line interface. The example input parameters 304a-h illustrated in FIG. 3 may for example, be implemented using a command line such as:

init -c0-t0-a-b-c1-a-t-s128 testcase.tc

The word “init” refers to the name of the initializer 106 and is used to invoke the initializer 106. The remaining text implements the input parameters 304a-h and specifies the filename of the test case 102 (i.e., “testcase.tc”). Each of the input parameters 304a-h includes a leading character (in this example, a hyphen), following by the name of the parameter (in this example, a single character), optionally followed by a value. The NULL values shown in FIG. 3 are therefore implemented by the lack of a value in the command line shown above. The command line text corresponding input parameters 304a-h is arranged in the same order as the input parameters 304a-h in FIG. 3.

Other ways for implementing the same input parameters 304a-h in a command line are well-known to those of ordinary skill in the art. For example, other leading characters, such as a slash (“/”), may be used. Alternatively, the leading characters may be omitted entirely. Some or all of the parameters may be separated by spaces to improve the readability of the command line. For example, the command line shown above may alternatively be expressed in the following way to emphasize the locations of scope-specifying parameters:

init -c0-t0-a-b-c1-a-t-s128 testcase.tc

Alternatively, for example, spaces may be provided after each parameter, as follows:

init -c0-t0-a-b-c1-a-t-s128 testcase.tc

The initializer 106 and the simulator 112 may be implemented as software programs written in the C programming language or any other programming language. The methods 400ab, the ApplyParam subroutines 412a-b, and the GetScope subroutine 460 may be implemented as functions in the C programming language or any other programming language. The microprocessor design 110 may be implemented as a data structure stored in the memory of a computer or on a storage medium such as a hard disk.

Among the advantages of the invention are one or more of the following.

One advantage of the techniques disclosed herein is that they provide a convenient and efficient way to specify parameters having varying scopes. For example, if multiple parameters to a process (such as the initialization process performed by the initializer 106) have the same scope, the techniques disclosed herein may be used to specify the scope once using one or more scope-specifying parameters (such as the core-specifying parameter 304a and the thread-specifying parameter 304b in FIG. 3) and then to provide the multiple parameters having the specified scope. This obviates the need for the user to distinctly and redundantly specify the scope for each of multiple parameters having the same scope.

More generally, the techniques disclosed herein require the user to explicitly specify the scope of an input parameter only when the input parameter's scope differs from one of the previous input parameters in the sequence of input parameters 116. As a result, the user need only specify a particular input parameter's scope if and to the extent that the input parameter's scope differs from previous input parameters in the sequence of input parameters 116. The techniques disclosed herein may therefore reduce the amount of effort required by the user to construct the input parameters 116 and increase the efficiency with which the input parameters 116 express the desired information to the input parameter parser 106.

The techniques disclosed herein are particularly useful for providing multiple parameters through a textual command line interface. A textual command line is a linear (i.e., flat) sequence of text which is typically parsed by reading and processing its parameters sequentially. The techniques disclosed herein allow parameters of varying scopes to be specified efficiently using a single linear sequence of parameters which may be parsed sequentially to apply the parameters within their intended scope. A user may, for example, use the techniques disclosed herein to specify parameters of varying scope in a single command line rather than in multiple command lines, each of which specifies parameters of a distinct scope. The techniques disclosed herein are therefore particularly well-suited for use in conjunction with textual command line interfaces.

Another advantage of techniques described herein is that they interpret and apply the probable intent of the input parameters during the parsing process. For example, referring again to FIG. 4C, if the current scope S_{C} is narrower than (over-specifies) or equal to the defined scope S_{P}, the ApplyParam subroutine 412a executes the executable code E_{P} (step 448a) and ignores any portion of the current scope S_{C} which is more specific than the defined scope S_{P}. If the current scope S_{C} is broader than (under-specifies) the defined scope S_{P}, the ApplyParam subroutine 412a applies the parameter P to all scopes in the scope range 120 (step 450). These steps embody assumptions about the intent of the user who provided the input parameters 116 in cases where the current scope S_{C} over-specifies or under-specifies the parameter P. In particular, these steps embody the assumption that any overspecifying portion of the current scope S_{C} is intended to be ignored and that an under-specified parameter is intended to be applied to all scopes within the scope range 120.

Embodying these assumptions in the input parameter parser 122 allows the parsing process to proceed (rather than terminate) even when parameters are over-specified (step 448a). Furthermore, applying an under-specified parameter to all scopes in the scope range 120 (step 450) allows the user to efficiently indicate that the parameter should be applied to all scopes in the scope range. In particular, the user may indicate that the parameter should be applied to all scopes in the scope range 120 by indicating a NULL scope followed by the parameter, rather than by providing a distinct parameter for each scope in the scope range 120. In this way, the techniques disclosed herein may save the user time and effort.

It should be appreciated, however, that the input parameter parser 122 may be implemented to embody alternative assumptions. For example, in an alternative embodiment, the ApplyParam routine 412a may alert the user or terminate with an error at step 448a if the current scope S_{C} is narrower than the defined scope S_{P}. Alternatively or additionally, the ApplyParam routine 412a may alert the user or terminate with an error at step 450 when the current scope S_{C} is broader than the defined scope S_{P}.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

Although some of the particular examples described herein relate to the initializer 106 and simulator 112, it should be appreciated that the techniques described herein may be applied more generally to any parameterized process.

Although in the examples provided above, the input parameter parser 122 sequentially reads the input parameters 116, this is not a requirement of the present invention. Rather, the input parameter parser 122 may read the input parameters 116 in any order, although reading the input parameters 116 sequentially may be advantageous in particular embodiments. The input parameter parser 122 may, for example, read the input parameters 116 non-sequentially but apply the input parameters 116 sequentially to the parameterized process (e.g., the initialization process performed by the initializer 106).

Although the scope of parameters related to the microprocessor design 110 is defined herein by a combination of a core number and thread number, this is merely an example and not a limitation of the present invention. Rather, a particular scope may be specified by any number and combination of scope-specifying parameters. For example, in a single-core, multi-thread architecture, a scope may be specified by a single thread number.

The scopes of different normal parameters may be specified by different numbers of scope-specifying parameters. For example, the scope of a normal parameter having a core-specific scope may be specified solely by a core number, while the scope of a normal parameter having a thread-specific scope may be specified by a combination of a core number and thread number.

Although the parameter definitions 204a-f illustrated in FIG. 2 define a distinct scope for each parameter, this is not a requirement of the present invention. One or more parameters, for example, may not have a defined scope. In the case of such a parameter, the ApplyParam subroutine 412a (FIG. 4C) may, for example, apply the parameter solely within the current scope S_{C} (step 448a) or within all scopes in the scope range 120 (step 450).

The description herein refers to the use of a NULL value, for example, with respect to the input parameter definitions 204a-f (FIG. 2) and the input parameters 116. The NULL value may be implemented in any of a variety of ways. For example, the NULL value may be represented by a value, such as −1, which does not represent a valid parameter value in the context in which it is used. Such a value may not be valid, for example, because it is out of range or because it is an undefined value. For example, in a system in which cores are numbered sequentially beginning with zero, a core number of −1 is out of range and may therefore represent the NULL value. Alternatively, some computer programming environments define non-numeric values (such as values indicating an arithmetic overflow) which may be used as the NULL value.

The NULL value may be represented by the same or different values in different contexts. For example, the NULL value in the input parameter definitions 124 (FIG. 2) may be represented by −1, while the NULL value in the input parameters 116 (FIG. 3) may be represented by the absence of a value.

Elements and components described herein may be further divided into additional components or joined together to form fewer components for performing the same functions.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and nonvolatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising steps of:
(A) receiving a first parameter of a process, the first parameter specifying a first scope;
(B) receiving a second parameter of the process; and
(C) applying the second parameter to the process within the first scope.

2. The method of claim 1, wherein the step (B) is performed after the step (A).

3. The method of claim 1, wherein the step (A) comprises a step of receiving the first parameter from a text string provided through a textual command-line interface, and wherein the step (B) comprises a step of receiving the second parameter from the text string.

4. The method of claim 3, wherein the first parameter corresponds to first text in the text string, and wherein the second parameter corresponds to second text occurring after the first text in the text string.

5. The method of claim 1, further comprising steps of:
(D) receiving a third parameter of the process; and
(E) applying the third parameter to the process within the first scope.

6. The method of claim 1, wherein the step (C) comprises steps of:
(C)(1) identifying a second scope of the second parameter;
(C)(2) determining whether the second scope is equal to the first scope; and
(C)(3) applying the second parameter to the process within the first scope if the second scope is determined to be equal to the first scope.

7. The method of claim 6, further comprising steps of:
(C)(4) determining whether the second scope is broader than the first scope; and
(C)(5) applying the second parameter to the process within the second scope if the second scope is determined to be broader than the first scope.

8. The method of claim 6, further comprising steps of:
(C)(4) determining whether the second scope is narrower than the first scope;
(C)(5) identifying a range of scopes; and
(C)(6) applying the second parameter to all scopes in the range of scopes if the second scope is determined to be narrower than the first scope.

9. The method of claim 1, wherein the first scope comprises a scope of a machine resource in a microprocessor design.

10. The method of claim 9, wherein the first scope comprises a scope of a thread in a multi-thread microprocessor design.

11. The method of claim 9, wherein the first scope comprises a scope of a core in a multi-core microprocessor design.

12. The method of claim 11, wherein the first scope comprises a scope of a thread in a multi-thread microprocessor design.

13. A computer system comprising:
first receiving means for receiving a first parameter of a process, the first parameter specifying a first scope;
second receiving means for receiving a second parameter of the process; and
first application means for applying the second parameter to the process within the first scope.

14. The system of claim 13, wherein the first receiving means comprises means for receiving the first parameter from a text string provided through a textual command-line interface, and wherein the second receiving means comprises means for receiving the second parameter from the text string.

15. The system of claim 14, wherein the first parameter corresponds to first text in the text string, and wherein the second parameter corresponds to second text occurring after the first text in the text string.

16. The system of claim 13, further comprising:
third receiving means for receiving a third parameter of the process; and
second application means for applying the third parameter to the process within the first scope.

17. The system of claim 13, wherein the first application means comprises:
means for identifying a second scope of the second parameter;
means for determining whether the second scope is equal to the first scope; and
means for applying the second parameter to the process within the first scope if the second scope is determined to be equal to the first scope.

18. The system of claim 17, further comprising:
means for determining whether the second scope is broader than the first scope; and
means for applying the second parameter to the process within the second scope if the second scope is determined to be broader than the first scope.

19. The system of claim 17, further comprising:
means for determining whether the second scope is narrower than the first scope;
means for identifying a range of scopes; and
means for applying the second parameter to all scopes in the range of scopes if the second scope is determined to be narrower than the first scope.

20. The system of claim 13, wherein the first scope comprises a scope of a machine resource in a microprocessor design.

21. The system of claim 20, wherein the first scope comprises a scope of a thread in a multi-thread microprocessor design.

22. The system of claim 20, wherein the first scope comprises a scope of a core in a multi-core microprocessor design.

23. The system of claim 22, wherein the first scope comprises a scope of a thread in a multi-thread microprocessor design.

24. A computer-implemented method comprising steps of:
(A) initializing a current scope of a process;
(B) receiving a first parameter of the process;
(C) determining whether the first parameter is a scope-specifying parameter which specifies a new scope of the process;
(D) applying the first parameter to the process within the current scope if it is determined that the first parameter is not a scope-specifying parameter; and
(E) if it is determined that the first parameter is a scope-specifying parameter, performing steps of:
(1) updating the current scope with the new scope;
(2) receiving a second parameter of the process; and
(3) applying the second parameter to the process within the updated current scope.

25. The method of claim 24, wherein the step (E)(3) is performed after the step (D).

26. The method of claim 24, wherein the step (B) comprises a step of receiving the first parameter from a text string provided through a textual command-line interface, and wherein the step (E)(2) comprises a step of receiving the second parameter from the text string.

27. The method of claim 26, wherein the first parameter corresponds to first text in the text string, and wherein the second parameter corresponds to second text occurring after the first text in the text string.

28. The method of claim 24, wherein the first scope comprises a scope of a machine resource in a microprocessor design.

29. The method of claim 28, wherein the first scope comprises a scope of a thread in a multi-thread microprocessor design.

30. The method of claim 28, wherein the first scope comprises a scope of a core in a multi-core microprocessor design.

31. The method of claim 30, wherein the first scope comprises a scope of a thread in a multi-thread microprocessor design.

32. A computer system comprising:
means for initializing a current scope of a process;
first receiving means for receiving a first parameter of the process;
means for determining whether the first parameter is a scope-specifying parameter which specifies a new scope of the process;
first application means for applying the first parameter to the process within the current scope if it is determined that the first parameter is not a scope-specifying parameter; and
means for performing the following steps if it is determined that the first parameter is a scope-specifying parameter: (1) updating the current scope with the new scope; (2) receiving a second parameter of the process; and (3) applying the second parameter to the process within the updated current scope.

33. The system of 32, wherein the first receiving means comprises means for receiving the first parameter from a text string provided through a textual command-line interface, and wherein the means for receiving the second parameter of the process comprises means for receiving the second parameter from the text string.

34. The system of claim 33, wherein the first parameter corresponds to first text in the text string, and wherein the second parameter corresponds to second text occurring after the first text in the text string.

35. The system of claim 32, wherein the first scope comprises a scope of a machine resource in a microprocessor design.

36. The system of claim 35, wherein the first scope comprises a scope of a thread in a multi-thread microprocessor design.

37. The system of claim 35, wherein the first scope comprises a scope of a core in a multi-core microprocessor design.

38. The system of claim 37, wherein the first scope comprises a scope of a thread in a multi-thread microprocessor design.
